(19) United States
(12) Patent Application Publication
(10) Pub. No.: US 2016/0345603 A1
(43) Pub. Date: Dec. 1, 2016

(54) MACHINE FOR REFRIGERATION BY DRY ICE

(71) Applicant: EREIE - ENERGY RESEARCH INNOVATION ENGINEERING, Palaiseau (FR)

(72) Inventors: Denis CLODIC, Palaiseau (FR); Christian MICHAUD, Palaiseau (FR)

(73) Assignee: EREIE - ENERGY RESEARCH INNOVATION ENGINEERING, Palaiseau (FR)

(21) Appl. No.: 15/117,780

(22) PCT Filed: Feb. 12, 2015
(86) PCT No.: PCT/FR2015/050349

§ 371 Date: Aug. 10, 2016

(30) Foreign Application Priority Data
Feb. 21, 2014 (FR) 14 51426

(51) Int. Cl. A23G 9/06; A23G 9/22; A23G 9/08

(52) U.S. Cl. CPC A23G 9/06; A23G 9/08; A23G 9/228

(57) ABSTRACT

A method of refrigerating a product by a refrigeration machine, including a source of supply of refrigerant fluid, a conduit to evacuate the refrigerant fluid, and a refrigeration chamber to receive the product to be refrigerated. The product is contained in a container disposed in the refrigeration chamber. The method involves an operation of refrigerating the refrigeration chamber by the refrigerant fluid and evacuating the refrigerant fluid by the conduit, wherein the container is in direct contact with the refrigerant fluid.

The invention relates to machines for manufacturing iced desserts as well as methods for manufacturing said products.

Products such as ice creams, Italian ices or sorbets are considered to be iced desserts.

Typically, an ice cream is composed of 32% freezable water, 32% non-freezable water, 12% freezable lipids, 12% non-freezable lipids, 3% proteins and 9% glucides. An Italian ice or sorbet contains 62% water, 25% glucides, 10% lipids and 3% proteins; here again, the freezable and non-freezable fractions of the water and lipids represent 50% of the masses of water and lipids.

Various machines for producing these ices are known. They are found in particular in tourist areas on sunny days, or in fast-food outlets.

For the past several decades, personal ice machines have been making their appearance. The idea is to enable anyone to produce iced desserts at home in family-size proportions, with the additional advantage of being able to customize the preparations based on the taste and food preferences of each person; see for example the American patent application published under no. 2013/0340456 (RICHARD HOARE).

In this prior American document, the ice machine comprises a tank intended to receive ingredients and a mixing machine actuated by an electric motor to mix the preparation. The cooling of the tank is achieved by means of a heat pump comprising the usual elements, namely a compressor, a condenser, a pressure-reducing valve and an evaporator. The tank is surrounded by the evaporator, where the refrigerant fluid is evaporated, removing the heat from the tank, before reaching the compressor.

These devices have three major disadvantages. The first is that in order to obtain an iced dessert, the various ingredients of a recipe must be added. The second is that the iced dessert is not ready immediately because it requires preparation time. Finally, the cooling of the preparation is slow.

There are industrial techniques for rapidly cooling an iced dessert preparation (see for example the publication from the Massachusetts Institute of Technology entitled “Carbon Dioxide Flash-Freezing Applied to Ice Cream Production”). The method of manufacturing ice cream requires liquid carbon dioxide and an ice cream premix. The term “premix” refers to a culinary composition. The carbon dioxide and the premix are pre-cooled to a temperature close to the water solidification temperature. The premix is then sprayed in the form of a fine mist into the liquid carbon dioxide, thus creating a temporary emulsion. The emulsion is then sprayed into a chamber at a lower pressure, and under saturation conditions of the carbon dioxide at −20° C., the carbon dioxide is sublimated and the premix is instantly frozen.

This type of device is advantageous in an industrial environment for mass production, but does not lend itself to domestic use. Furthermore, the premix must be prepared, which involves an undesirable loss of time.

Another technique published in American patent application no. 2009/0277208 (KLAUS EICHLER) consists of placing a series of molds containing a product, particularly ice cream, in a refrigeration chamber. A refrigeration system in which carbon dioxide circulates cools the walls of the refrigeration chamber. To ensure better conductivity, the chamber is filled with water.

This device has one major disadvantage: it requires the addition of water to enable more efficient refrigeration. Indeed, if the walls of the chamber cooled by the refrigeration system are not in direct contact with the walls of the molds, then the cooling is not optimal, because air is not as efficient a thermal conductor as water. Moreover, even if the walls of the molds and of the chamber are in contact, it would appear that the thermal conductivity comes at a cost of greater consumption of carbon dioxide and loss of time.

A first objective is to propose an ice machine offering individual portions.

A second objective is to propose an ice machine enabling an ice to be produced in no more than a few tens of seconds.

A third objective is to propose an ice machine whose dimensions are reasonably suited for a domestic environment.

A fourth objective is to propose an ice machine that does not require a premix prepared by the user.

To that end, a method is first proposed of refrigerating a product such as a premix by means of a refrigeration machine that comprises:
a source of supply of refrigerant fluid;
a conduit intended to evacuate the refrigerant fluid;
a refrigeration chamber intended to receive the product to be refrigerated.

In said machine, the product is contained in a container, said container being disposed inside the refrigeration chamber.

This method comprises an operation of:
refrigerating the refrigeration chamber by means of the refrigerant fluid;
evacuating the refrigerant fluid by means of the conduit. The refrigerating operation of the refrigeration chamber is achieved by injection of the refrigerant fluid directly into the refrigeration chamber, the container containing the product thus being in direct contact with the refrigerant fluid, the container comprising an upper shell, a lower shell and means of securing the lower shell to the upper shell, the refrigerant fluid being expanded at atmospheric pressure by spraying into the refrigeration chamber.

The device thus has the advantage of being able to prepare an iced dessert in a few tens of seconds and without any preparation needed by the user. Also, it is not necessary to add various contrivances to improve the heat exchange at the container.

Various additional characteristics can be foreseen, alone or in combination:
the evacuation operation is done by evaporation of the refrigerant fluid into the atmosphere;
the refrigerant fluid is carbon dioxide in liquid and gaseous phase from a source of supply;
the refrigerating operation is achieved by expansion of the carbon dioxide at atmospheric pressure, the carbon dioxide thus becoming dry ice.

Secondly, a machine is proposed for refrigerating a product such as a premix for producing iced desserts, said refrigeration machine comprising:
a source of supply of refrigerant fluid;
a conduit intended to evacuate the refrigerant fluid;
a refrigeration chamber disposed to receive the product;
   the product being contained in a container disposed in the refrigeration chamber, machine in which the refrigeration chamber is disposed in such a way that the refrigerant fluid is in direct contact with the container, the container comprising an upper shell and a lower shell and means of securing the lower shell to the upper shell.

Various additional characteristics can be foreseen, alone or in combination:
the source of supply is a storage tank, said storage tank containing carbon dioxide in liquid and gaseous phase or in supercritical state;
the machine comprises a body, said body comprising a base and defining a seat for receiving the carbon dioxide storage tank;
the machine comprises a supply system, said supply system being governed by a valve;
the refrigeration chamber is provided with an upper part and a lower part, the lower part comprising a container holder that defines a receptacle for receiving the container;
the machine comprises a control unit enabling a hard ice or a soft ice to be produced, said control unit being disposed to perform the steps consisting of:
verifying the presence of the lower part on the upper part;
   if the lower part is detected on the upper part,
sending a command to open the valve;
maintaining the valve open for a predetermined period of time;
sending a command to close the valve;
   if the user chooses to have a hard ice,
sending a command to open the valve after a ten-second delay;
maintaining the valve open for a predetermined period of time;
sending a command to close the valve;
signaling that the iced dessert is ready.

Other characteristics and advantages will be seen more clearly and specifically from the following description of embodiments, which is provided with reference to the appended drawings in which:

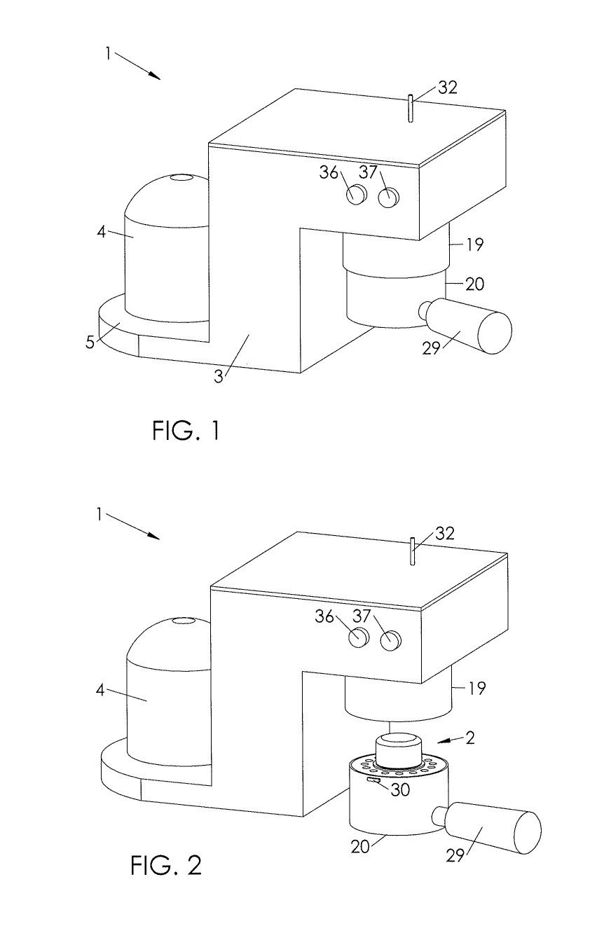

FIG. 1 is a view in perspective of a freezing machine according to one embodiment of the invention;

FIG. 2 is a view in perspective of a freezing machine according to one embodiment of the invention;

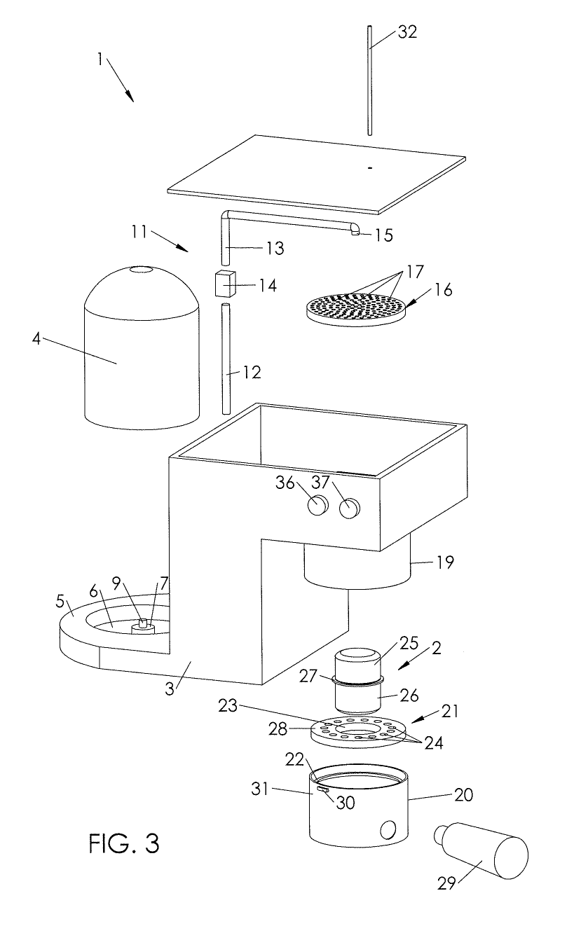

FIG. 3 is an exploded view of a freezing machine according to one embodiment of the invention;

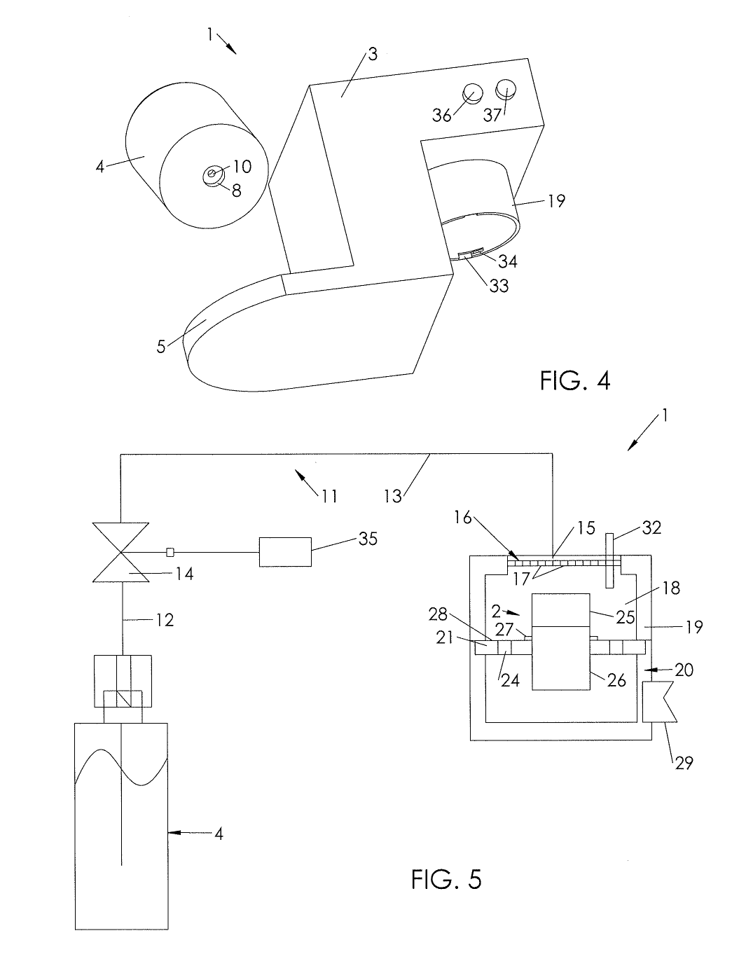

FIG. 4 is a view in perspective of a freezing machine showing in particular the bottom thereof, according to one embodiment of the invention;

FIG. 5 is a schematic view of a freezing machine according to one embodiment of the invention;

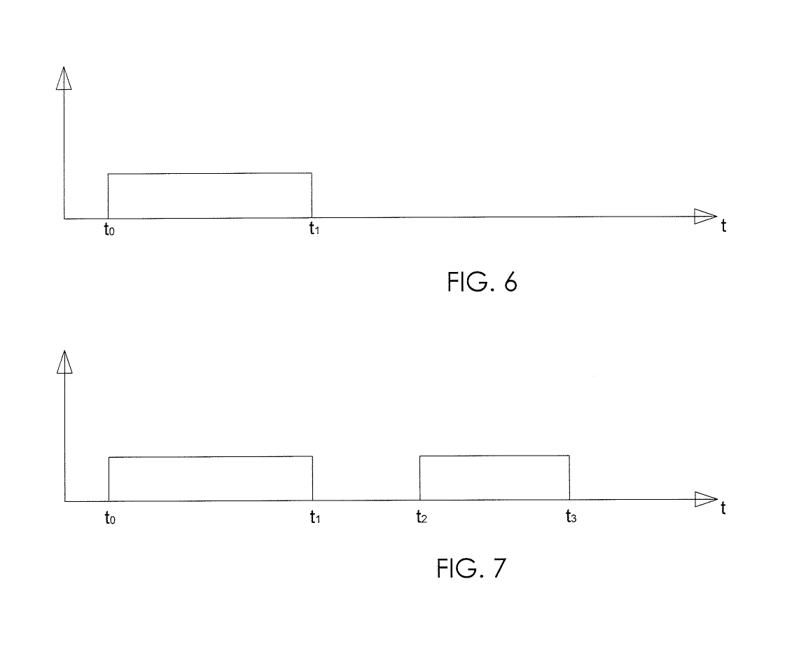

FIG. 6 is a time chart;

FIG. 7 is a time chart.

Represented in FIGS. 1 and 2 is a machine 1 for refrigerating iced desserts from a premix contained in a container, hereinafter called capsule 2.

FIG. 3 is an exploded illustration of the refrigeration machine 1 in which the components for its operation according to one embodiment can be seen in detail.

With reference to FIG. 3, the refrigeration machine 1 comprises a body 3 on which a series of components are assembled. Included among these components is, in particular, a storage tank 4. Stored in said storage tank 4 is carbon dioxide (CO₂) in liquid and gaseous state, respectively in the typical proportions of 80% and 20%; if the temperature is higher than 31° C., the carbon dioxide is then in supercritical state. The supercritical state does not significantly change the refrigerant power of the carbon dioxide when it is at atmospheric pressure.

The body 3 of the refrigeration machine 1 is provided with a base 5 intended to receive the storage tank 4. In order to position the storage tank 4 easily on the body 3 of the refrigeration machine 1, the base 5 comprises a seat 6, the section of which is identical to that of the storage tank 4. In the embodiment represented in the figures, the seat 6 is annular and of circular section. The seat 6 is further provided with an indexing stem 7 intended to cooperate with an indexing cavity 8 located on the storage tank 4. Finally, the seat 6 is also provided with a pin 9 pressing on a non-return valve 10 (when the storage tank 4 is in the seat 6), thus enabling the carbon dioxide under pressure in the storage tank 4 to escape therefrom.

The pin 9 comprises a series of orifices (not shown) for the passage of the carbon dioxide; the carbon dioxide thus collected is carried under the effect of the internal pressure of the storage tank 4 by a supply system 11. The supply system 11 comprises a first tube 12 and a second tube 13, separated from each other by a valve 14.

The valve 14 has an open position and a closed position and is switched by means of an actuator controlled by a control unit that will be detailed hereinafter.

The second tube 13 comprises an atomizer 15 at its distal end. The atomizer 15 enables the carbon dioxide to be sprayed over a distribution grille 16. The distribution grille 16 is perforated by a series of orifices 17 disposed over its entire surface. The carbon dioxide is then distributed through the orifices 17 into a refrigeration chamber 18, where, in particular, the capsule 2 containing the premix is located.

The refrigeration chamber 18 is composed of an upper part 19 defining a first volume and a lower part 20 defining a second volume. Together, the first and second volumes form the refrigeration chamber 18.

The capsule 2 rests on a container holder, hereinafter called capsule holder 21. The capsule holder 21 is arranged in the lower part 20 and rests on an annular rib 22 providing a flanged interface for the capsule holder 21. The capsule holder 21 has a section substantially identical to that of the lower part 20 and of the upper part 19. The capsule holder 21 comprises at its center a receptacle 23 enabling the capsule 2 containing the premix to be received. In addition to the receptacle 23, the capsule holder 21 is perforated over its periphery with a series of holes 24 forming a passage so that the carbon dioxide from the atomizer 15 can reach the lower part.

The capsule 2 comprises an upper shell 25 and a lower shell 26. The lower shell 26 is equipped with a support 27 intended to cooperate with an upper face 28 of the capsule holder 21. In one embodiment represented in the figures, the support 27 is annular and protrudes with respect to the lower shell 26. The lower shell 26 further comprises means enabling the upper shell 25 to be secured. Said means can take various forms. For example, the upper shell 25 can be provided with threading, and the lower shell 26 can have threading with a tamper-proof ring in order to assure the user that the premix contained in the capsule 2 has not been altered. The premix is therefore disposed in the capsule 2, and said capsule is assembled by screwing the upper shell 25 onto the lower shell 26 and sealed by means of the tamper-proof ring.

The lower part 20 is provided with a handle 29 so that a user can manipulate it. The lower part 20 comprises means for securing it onto the upper part 19. Said means are in the form of lugs 30 that protrude with respect to an outer wall 31 of the lower part 20.

The evacuation of the carbon dioxide is done by means of a conduit 32, one end of which is in the upper part 19 of the refrigeration chamber 18, and the other end of which is open to the exterior.

The securing of the lower part 20 onto the upper part 19 is done by first positioning the lower part 20 facing the upper part 19 as illustrated in FIG. 2, then by inserting the lugs 30 into the indexing rails 33 made in the upper part 19, and finally by pivoting the lower part 20 around its axis in such a way that the lugs 30 slip into the indentations 34. Thus, the lower part 20 is secured to the upper part 19. Gaskets (not shown) are disposed between the upper part 19 and the lower part 20 in order to make the refrigeration chamber 18 perfectly hermetic.

Nevertheless, the securing means can take another form. Thus, instead of lugs, the lower part 20 can have threading that would cooperate with threading in the upper part 19. Other means can consist of direct snap-on of the lower part 20 onto the upper part 19, a disengagement button making it possible to separate them.

The principle of operation of the refrigeration machine 1 will now be described with reference to FIG. 5. FIG. 5 illustrates a simplified view of the elements of the refrigeration machine 1. Starting with the storage tank 4, when a command is given to open the valve 14, the liquid carbon dioxide flows into the supply system 11 under the effect of the internal pressure inside the storage tank 4. The carbon dioxide is sprayed over the distribution grille 16, which homogenizes the distribution in the refrigeration chamber 18. In the refrigeration chamber 18, the carbon dioxide flows around the capsule 2, passing in particular through the capsule holder 21 by means of the holes 24. In the refrigeration chamber 18, the carbon dioxide undergoes an expansion that results in a sharp drop in the temperature in the refrigeration chamber 18, resulting in the rapid cooling of the capsule 2 and of the premix contained therein.

The phenomenon of the sharp drop in temperature is explained by the phase diagram of the carbon dioxide. Initially, in the storage tank 4, the carbon dioxide is unstable; that is, it is in the gaseous and liquid phase at the same time. In the following, our assumption is that the carbon dioxide is stored at 20° C. At that temperature, the carbon dioxide is stored in the storage tank 4 at a pressure of about 57.3 atm (1 atm equals 101,325 Pa).

In the refrigeration chamber 18, the carbon dioxide is quickly expanded at the atmospheric pressure (1 atm). The temperature then drops sharply from 20° C. (ambient temperature) to −78° C., and this occurs nearly instantaneously. The carbon dioxide is solidified, forming what is commonly called dry ice. Then at atmospheric pressure, the dry ice is sublimated by absorbing the heat, thus cooling the capsule. On a CO₂ temperature/entropy phase diagram, this is shown by sublimation at −78° C. or 195 K with a sublimation heat of more than 550 kJ/kg and an average thermal capacity of 1.5 kJ/(kg.K) between −78° C. and 20° C. This sharp difference in temperature and high phase change heat makes it possible to cool and then freeze 50% of the water of the premix and 50% of the lipids, with an enthalpy of 330 kJ/kg for the water and 63 kJ/kg for the lipids, for a cooling from 20° C. to −12° C. or −18° C., with respective heat capacities of the water and lipids on the order of 4.18 kJ/(kg.K) and 2.1 kJ/(kg.K).

For an ice cream composed of 32% freezable water, 12% freezable lipids, 3% proteins and 9% glucides, we will respectively need latent heat of about 100 kJ/kg for the water (32%×330 kJ/kg), about 8 kJ/kg for the freezable lipids (12%×63), in order to change from a temperature of 20° C. to a temperature of 0° C. Then, an additional 10 kJ/kg are needed for the premix to reach a temperature of −12° C. Therefore, a total of about 120 kJ/kg will be needed to cool the premix to the desired temperature. Compared to the sublimation heat of the CO₂, which is 550 kJ/kg as previously mentioned, the latent heat necessary to cool the premix is far less.

In order to ensure cooling in a minimum amount of time, the latent heat from the phase change of the CO₂ is at least about five times greater than the cooling needs of the iced dessert. Taking into account the heat losses associated with the circulation of the liquid CO₂ in the machine and the cooling of the capsule holder, which absorbs part of the heat from the CO₂, calculation shows that the mass of dry ice needed for the cooling is 50% of the mass of the iced dessert under the most unfavorable conditions. “Most unfavorable conditions” is understood as being at ambient temperature and first use of the machine. Indeed, once the machine has been used, it remains cold for a certain amount of time.

The refrigeration machine 1 also comprises a control unit 35 for performing the different tasks for producing an iced dessert. A program is implemented in the control unit 35. The computer program starts when the user presses one of the two buttons 36, 37. The soft ice button 36 enables the capsule 2 to be cooled to a temperature of about −12° C., which produces an ice of soft texture. The hard ice button 37 cools the capsule 2 to a temperature of −18° C., which produces an ice of hard texture. When the soft ice button 36 is pressed, the computer program first verifies that the lower part 20 is positioned on the upper part 19, by means of a position detector (not shown). If the position detector does not detect the lower part 20, the freezing process does not start. If the detector sends a positive signal signifying that the lower part 20 is secured to the upper part 19, then the computer program sends a signal at instant t₀ to open the valve 14 as illustrated in FIG. 6, which order the valve 14 performs after a delay called response time. The valve 14 remains open for a predetermined time, which allows the necessary quantity of carbon dioxide to pass. At an instant t₁, the computer program sends a signal to the valve 14 to close. The carbon dioxide migrates towards the refrigeration chamber 18, where it becomes dry ice. The dry ice cools the capsule 2 down to a temperature of −12° C. in about 30 seconds. The program triggers an audible signal when the iced dessert is ready.

When the hard ice button 37 is pressed, the computer program verifies the presence of the lower part 20 and starts the intensified cooling process. At an instant t₀, a signal is sent and the valve 14 is opened, then closed at an instant t₁. The cooling is then intensified by sending a new signal to open the valve 14 at an instant t₂, 10 seconds after t₁; then said valve is closed at an instant t₃ after a predetermined time as illustrated in FIG. 7. The iced desert is then frozen at a temperature of −18° C.

The machine and the method offer the user unprecedented ease-of-use. The capsules 2, available to please any palate, make it possible to enjoy an individual portion of an iced dessert while choosing the refrigerating mode.

The invention also uses the properties of the carbon dioxide in order to rapidly freeze the capsule 2. This offers the user an ice that is ready in just a few tens of seconds.

Finally, the machine hardly needs any cleaning since the dry ice is sublimated and evacuated without leaving traces. No maintenance is necessary.

1. A method of refrigerating a premix for producing iced desserts by a refrigeration machine that comprises:
a source of supply of refrigerant fluid;
a conduit intended to evacuate the refrigerant fluid;
a refrigeration chamber intended to receive the premix to be refrigerated;
machine wherein the premix is contained in a container, said container being disposed in the refrigeration chamber, wherein said method comprises an operation of:
refrigerating the refrigeration chamber by means of the refrigerant fluid;
evacuating the refrigerant fluid by means of the conduit;
wherein the operation of refrigerating the refrigeration chamber is achieved by injection of the refrigerant fluid directly into the refrigeration chamber, the container containing the product thus being in direct contact with the refrigerant fluid, the container comprising an upper shell and a lower shell and means of securing the lower shell to the upper shell, the refrigerant fluid being expanded at atmospheric pressure by spraying into the refrigeration chamber.

2. The refrigeration method according to claim 1, wherein the evacuation operation is achieved by evaporation of the refrigerant fluid into the atmosphere.

3. The refrigeration method according to claim 1, wherein the refrigerant fluid is carbon dioxide in liquid and gaseous phase from the source of supply.

4. The refrigeration method according to claim 3, wherein the refrigerating operation is achieved by expansion of the carbon dioxide at atmospheric pressure, the carbon dioxide thus becoming dry ice.

5. A machine for refrigerating a premix for producing iced desserts, said refrigeration machine comprising:
a source of supply of refrigerant fluid;
a conduit intended to evacuate the refrigerant fluid;
a refrigeration chamber disposed to receive the product;
the product being contained in a container disposed inside the refrigeration chamber, wherein the refrigeration chamber is arranged in such a way that the refrigerant fluid is in direct contact with the container, the container comprising an upper shell and a lower shell and means of securing the lower shell to the upper shell.

6. The refrigeration machine according to claim 5, wherein the source of supply is a storage tank, said storage tank containing carbon dioxide in liquid and gaseous or supercritical phase.

7. The refrigeration machine according to claim 6, wherein the machine comprises a body, said body comprising a base defining a seat for receiving the carbon dioxide storage tank.

8. The refrigeration machine according to claim 5, wherein the machine comprises a supply system, said supply system being controlled by a valve.

9. The refrigeration machine according to claim 5, wherein the refrigeration chamber is provided with an upper part and a lower part, the lower part comprising a container holder defining a receptacle for receiving the container.

10. The refrigeration machine according to claim 9, wherein the machine comprises a control unit enabling a hard ice or a soft ice to be produced, said control unit being disposed to perform the steps comprising:
verifying the presence of the lower part on the upper part;
if the lower part is secured to the upper part,
sending a command to open the valve at t₀;
maintaining the valve open for a predetermined period of time;
sending a command to close the valve at t₁;
if the user chooses to have a hard ice,
sending a command to reopen the valve after a delay of a few seconds, at t₂;
maintaining the valve open for a predetermined period of time;
sending a command to close the valve at t₃;
signaling that the iced dessert is ready.
